(19) United States
(12) Patent Application Publication
(10) Pub. No.: US 2010/0050200 A1
(43) Pub. Date: Feb. 25, 2010

(54) PROGRAM INFORMATION PROMPTING METHOD AND APPARATUS AND TELEVISION SET USING THE SAME

(75) Inventors: Cheng-Hung Tsai, Taipei (TW); Fou-Ming Liou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/498,372

(22) Filed: Jul. 7, 2009

(30) Foreign Application Priority Data
Aug. 25, 2008 (TW) 97132427

(51) Int. Cl. H04H 60/33; G06K 9/00

(52) U.S. Cl. 725/9; 382/117

(57) ABSTRACT

A program information prompting method and apparatus and a television set using the same are provided. In the method, a user is identified at first. Then, a watching habit of the user is recorded. Next, program preference of the user is determined according to the watching habit. Afterwards, a prompt of related program information is given according to the user's program preference.

### CROSS-REFERENCE TO RELATED APPLICATION

This application claims the priority benefit of Taiwan application serial no. 97132427, filed on Aug. 25, 2008. The entirety of the above-mentioned patent application is hereby incorporated by reference herein and made a part of specification.

### BACKGROUND OF THE INVENTION

1. Field of the Invention

The invention relates to a program information prompting method and apparatus and a television set using the same and, more particularly, to a method and apparatus which may give a prompt of television program information according to a user's program preference and a television set using the same.

2. Description of the Related Art

The entertainment of most people is to stay at home, watch TV and enjoy randomly pressing buttons of a remote controller. To satisfy different audience groups, various programs such as cartoons, theaters, variety shows, news, education, sports and children's programs are broadcasted. Each kind of the programs has its own characters and styles. Since there are various kinds of programs, people have to spend much time searching channels to find their preferred programs, and this troubles many people.

The channel owners issues the television program guide via network, print media or other ways to allow audiences to obtain the related information of the television programs through these information platforms and choose their preferred programs. However, since the television program guide collects much program information, once the audience forgets to watch a preferred program at a predetermined time, he or she must have to wait for a second broadcast of the program.

### BRIEF SUMMARY OF THE INVENTION

One objective of the invention is to provide a program information prompting method which may give a prompt of related program information according to a user's program preference.

Another objective of the invention is to provide a program information prompting apparatus which may give a prompt of related program information on a screen of a television according to the user's program preference.

Still another objective of the invention is to provide a television which may give a prompt of related program information on the screen according to the user's program preference.

According to the above and other objectives, the invention provides a program information prompting method. In the method, a user is identified at first. Then, a watching habit of the user is recorded. Next, a program preference of the user is determined according to the user's watching habit. Afterwards, a prompt of the related program information is given according to the user's program preference.

To the above objectives, the invention provides a program information prompting apparatus. The apparatus includes a user identifying unit, a storage unit and a control unit. The user identifying unit is used to identify the user. The storage unit is used to store a personalized program database. The control unit is used to record the watching habit of the user in the personalized program database and by which determine the program preference of the user to give a prompt of the related program information on the screen of the television.

To the above objectives, the invention provides a television including a display unit and a program information prompting module coupled to the display unit. The program information prompting module includes a user identifying unit for identifying a user, a storage unit for storing a personalized program database and a control unit for recording the user's watching habit in the personalized program database to determine the user's program preference and thereby gives a prompt of related program information on the display unit of the television.

In the television according to an embodiment of the invention, the way in which the control unit records the user's watching habit includes recording a watching record including ordinarily watched channels and time periods of the user or setting preferred channels and time periods by the user himself or herself.

In the television according to an embodiment of the invention, the storage unit further stores an electronic program guide (EPG), and the way in which the control unit determines the user's program preference includes comparing the watching record with the television program information in the EPG to further determine the program preference of the user.

In the television according to an embodiment of the invention, the storage unit further stores the EPG, and the way in which the control unit determines the user's program preference includes comparing the watching record with the television program information in the EPG to further determine the program preference of the user.

In the invention, the identity of the user is identified at first, and then the user's watching habit is recorded and the program preference is determined according to the user's watching habit. Then, a prompt of related program information is given automatically. Therefore, the user may switch channels according to the prompting information, and he or she may not miss any preferred program.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing the program information prompting apparatus according to an embodiment of the invention and the coupling mode thereof.

FIG. 2 is a schematic diagram showing the personalized program database in an embodiment of the invention.

FIG. 3 is a schematic diagram showing the program information prompting apparatus according to another embodiment of the invention and the coupling mode thereof.

FIG. 4 is a schematic diagram showing the television in an embodiment of the invention.

FIG. 5 is a flow path showing the program information prompting method according to an embodiment of the invention.

### DETAILED DESCRIPTION OF THE EMBODIMENTS

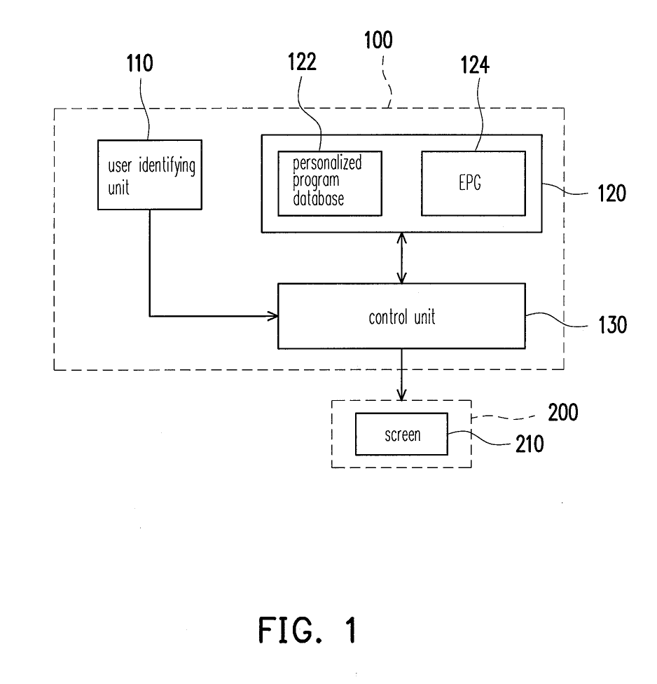

FIG. 1 is a schematic diagram showing a program information prompting apparatus according to an embodiment of the invention and the coupling mode thereof. In FIG. 1, the element denoted by 100 is the program information prompting apparatus, and the element denoted by 200 is a television. The components of the program information prompting apparatus 100 are firstly introduced concisely hereinbelow.

The program information prompting apparatus 100 includes a user identifying unit 110, a storage unit 120 and a control unit 130. The user identifying unit 110 is used to identify a user, and it may be achieved by a fingerprint identifier, a biology identifier, a pupil identifier or a three-dimensional environment automatic construction system. Note that the industry has developed related technique of the three-dimensional environment automatic construction system. The storage unit 120 is used to store a personalized program database 122 (illustrated in the following part) and an electronic program guide (EPG) 124 or similar electronic program lists. The control unit 130 is used to record the user's watching habit in the personalized program database 122 to determine the user's program preference. The control unit 130 also gives a prompt of the related program information on the screen 210 of the television 200 according to the user's program preference.

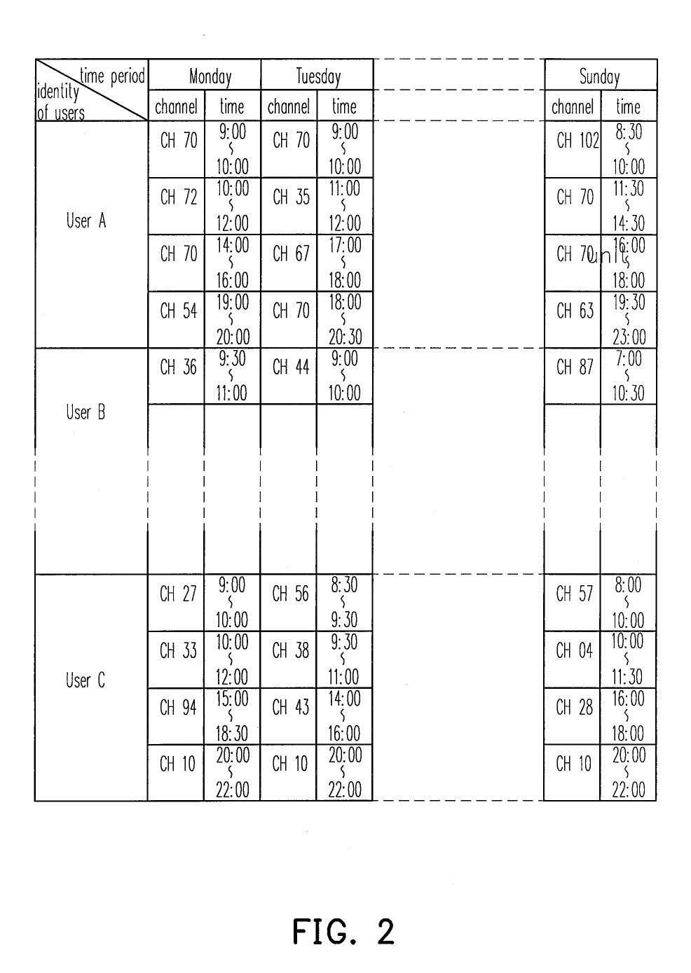

FIG. 2 is a schematic diagram showing the personalized program database 122 in an embodiment of the invention. As shown in FIG. 1 and FIG. 2, in the embodiment, the way in which the control unit 130 records the user's watching habit is to record a watching record including ordinarily watched channels and time periods of the user. For example, when a boy watches programs on Channel (CH) 70 at nine o'clock to ten o'clock and CH 72 at ten o'clock to twelve o'clock in a Monday morning, after he is identified by the control unit 130 to be user A in the personalized program database 122, the control unit 130 records CH 70 and CH 72 and the time periods during which the user watches CH 70 and CH 72 in the personalized program database 122.

When the boy watches programs in CH 70 and CH 54 at two o'clock to four o'clock in the afternoon and seven o'clock to eight o'clock in the evening, his identity also should be identified. In addition, the control unit 130 also records CH 70 and CH 54 and the time periods during which he watches CH 70 and CH 54 in the personalized program database 122.

Supposing that the boy watches TV everyday, in FIG. 2, the record related to the boy (that is user A) is gradually completed. FIG. 2 shows the watched channels and time periods of user A from Monday to Sunday. Since the EPG 124 may provide various kinds of television program information such as program names, program types, broadcasting time periods, movie introductions, main actor introductions, classes of the television programs of programs which may be played in recent weeks, as long as the control unit 130 compares ordinarily watched channels and the time periods of the boy with the television program information in the EPG 124, his program preference is obtained according to a specific concluding and analyzing rule such as the length of the program watching time or the watching frequency.

To take the boy's watching record as an example, as shown in FIG. 2, the boy is found often watching programs on CH 70 from Monday to Sunday. If the time periods during which the boy watches CH 70 are compared with the time periods of the programs in CH 70 in the EPG 124, at least a program name such as “American Major League Baseball Broadcast Program” is obtained and used as the program preference of the boy. Furthermore, other related program information with similar program names also may be compared, and for example, other programs named “American Major League Baseball Broadcast Program” also may be compared to obtain advanced program preference information. For example, information of the advanced program preference named “Broadcast Program of Baseball Player Jianmin Wang” is obtained.

As shown in FIG. 1, after the control unit 130 determines the program preference of the boy, a prompt of the related program information is given on the screen 210 of the television 200 according to his program preference. For example, the information “CH 70 will broadcast “American Major League Baseball Broadcast Program, player Jianmin Wang” at nine o'clock in the morning” is displayed in the screen 210. The screen 210 has a display unit, and the display unit is, for example, a liquid crystal screen, a plasma screen, or a projection screen. Thus, even though the boy does not watch programs broadcasted on CH 70, he or she also may switch the channel to CH 70 soon to watch programs according to the prompting information on the screen 210. This may prevent him from missing the wonderful baseball game due to watching other programs intensively.

Not only may the program name be used as the program preference of the user, all the television program information provided by the EPG 124 can be used as the program preference of the user. For example, a parental guided suggested movie is used as a program preference of the user. In addition, in the embodiment, the control unit 130 first collects the user's watching record in the past one week and then determines the user's program preference. However, the process of determining the program preference also may be performed every day or every month, and it is not limited. The determining frequency also may be adjusted according to the updating frequency of the EPG 124. Besides the EPG 124, the personalized program database 122 also may be updated regularly. To take the watching record of user A on Monday as an example, the watched channels and time periods at two consecutive Mondays are recorded, and a specific sorting method is used to obtain the channels which are watched by the user at the highest frequency and the watching time periods thereof. Other channels and the corresponding time periods are deleted.

In the above embodiment, the way in which the control unit 130 records the user's watching habit is to record ordinarily watched channels and time periods of the user. However, the user also may set the preferred channels and time periods himself. The benefit of doing this is that the control unit 130 may conclude and analyze information according to the user's setting directly, and the program preference is quickly obtained without collecting information for a long time.

Although FIG. 2 shows an aspect of the personalized program database 122, a skilled person in the art should know that the implementing mode of the personalized program database 122 may be varied according to the actual design requirement. It also may be realized by the specialized program database of the users. With variety of implementing modes of the personalized program database 122, the way in which the control unit 130 records the user's watching habit and the concluding and analyzing mode of the program preference also correspondingly vary.

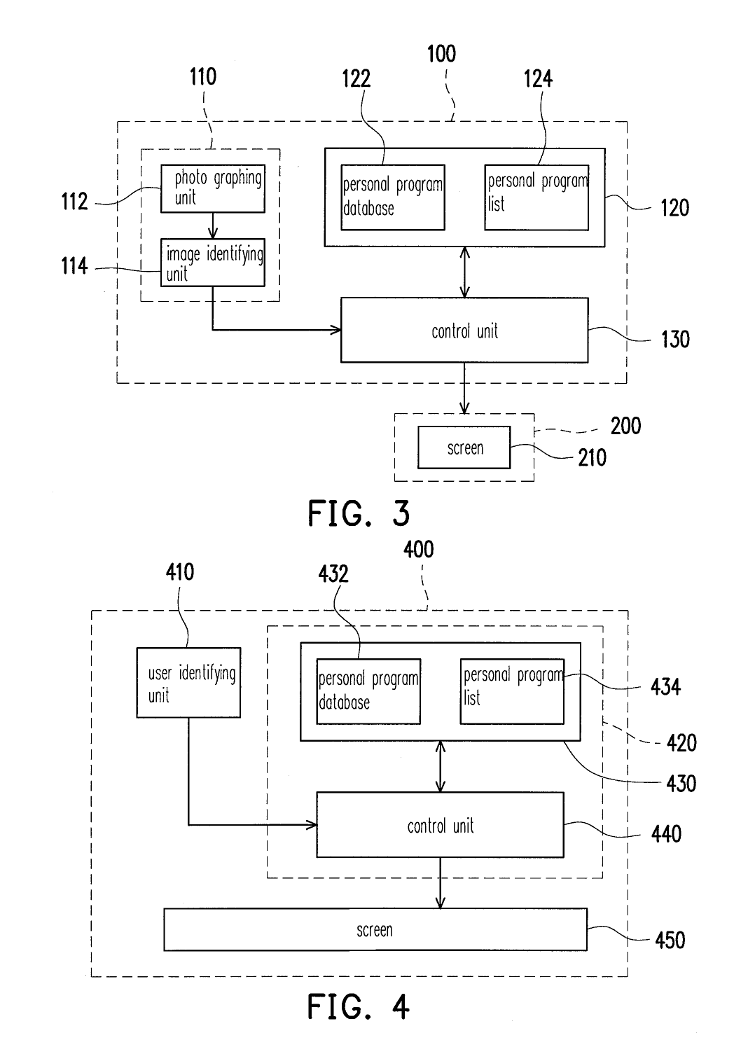

In FIG. 1, the user identifying unit 110 not only can be achieved by a fingerprint identifier, a biology identifier, a pupil identifier or a three-dimensional environment automatic construction system, it also may be achieved in other modes. As shown in FIG. 3, it is a schematic diagram showing the program information prompting apparatus according to another embodiment of the invention and the coupling method thereof. As shown in FIG. 1 and FIG. 3, the difference between FIG. 1 and FIG.3 is that the user identifying unit 110 is composed of a photographing unit 112 and an image identifying unit 114. The photographing unit 112 is used to get the image of the user, and a camera, a video camera such as a webcam may be used. The image identifying unit 114 is used to identify the identity of the user according to the image and transmit the determining result to the control unit 130. Thus, the control unit 130 may compare the determining result with the data of the users in the personalized program database 122. In addition, when the image which is obtained by the photographing unit 112 has multiple persons, the image identifying unit 114 chooses one of the persons as an identifying object.

The program information prompting apparatus not only can be independent to match with the television, but also may be integrated in the television directly. As shown in FIG. 4, it is a schematic diagram showing the television according to an embodiment of the invention. In FIG. 4, the element denoted by 400 is the television, which includes a user identifying unit 410, a program information prompting unit 420 and a screen 450. The program information prompting unit 420 includes a storage unit 430 and a control unit 440. The storage unit 430 is used to store the personalized program database 432, the EPG 434 and other similar electronic program lists. The screen 450 has a display unit, and the display unit is, for example, a liquid crystal screen, a plasma screen, a projection screen and so on. Since components in the user identifying unit 410 and the program information prompting unit 420 are similar to the corresponding components in the aforementioned program information prompting apparatus, they are not illustrated again for concise purpose. The better setting mode of the user identifying unit 410 is to dispose the user identifying unit 410 on the outer case (not shown) of the television or outside the television to provide convenient identification for the user. The television in the embodiment includes a display unit and program information prompting module. The display unit is coupled to the program information prompting module, and the program information prompting module includes a user identifying unit 410 to identify a user. The storage unit 430 is used to store a personalized program database, and a control unit 440 is used to record a watching record including ordinarily watched channels and time periods of the user in the personalized program database and to determine the program preference of the user. In addition, the control unit also may give a prompt of the related program information on the display unit of the television according to the program preference of the user.

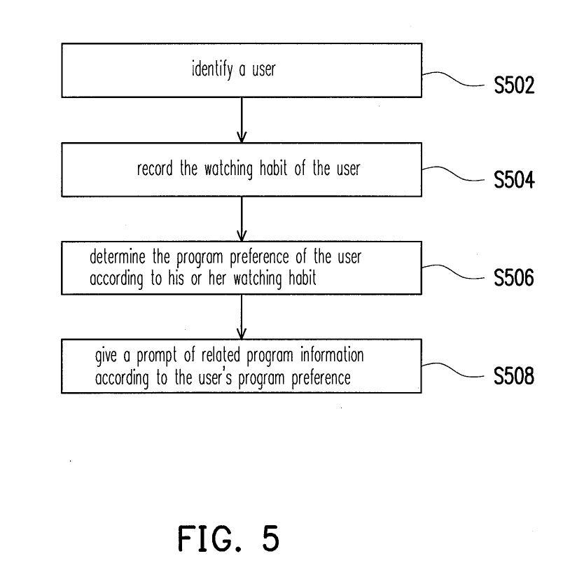

According to the operation mode of the embodiments, the basic flow path of the invention is provided. As shown in FIG. 5, it is a flow path showing the program information prompting method in an embodiment of the invention. In the method, a user is identified at first (as shown in step S502). Then, the watching habit of the user is recorded (as shown in step S504). Next, the program preference is determined according to the user's watching habit (as shown in S506). Afterwards, the prompt of program information is given according to the user's program preference (as shown in step S508).

To sum up, in the invention, the identity of the user is identified at first, and the user's watching habit, maybe a watching record including ordinarily watched channels and time periods of the user, is then recorded. Next, the program preference is determined according to the user's watching habit and the prompting information of the related program is given automatically. Thus, the user may switch channels according to the prompt of the program information, and he or she may not miss any preferred programs.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A program information prompting method comprising:
identifying a user;
recording a watching habit of the user;
determining a program preference of the user according to his or her watching habit; and
giving a prompt of related program information to the user according to the program preference of the user.

2. The program information prompting method according to claim 1, wherein the step of recording the watching habit of the user comprises recording a watching record including ordinarily watched channels and time periods of the user.

3. The program information prompting method according to claim 2, wherein the step of determining the user's program preference comprises comparing the watching record with television program information in an electronic program guide (EPG) to further determine the program preference of the user.

4. The program information prompting method according to claim 2, wherein the step of determining the program preference of the user comprises comparing the watching record with television program information in an EPG to further determine the program preference of the user.

5. A program information prompting apparatus comprising:
a user identifying unit for identifying a user;
a storage unit for storing a personalized program database; and
a control unit for recording the user's watching habit in the personalized program database to determine a program preference of the user and giving a prompt of related program information on a screen of a television.

6. The program information prompting apparatus according to claim 5, wherein the watching habit recorded by the control unit comprises a watching record including ordinarily watched channels and time periods of the user.

7. The program information prompting apparatus according to claim 6, wherein the storage unit further stores an EPG with a television program information, and the control unit determines the program preference of the user by comparing the watching record with the television program information in the EPG to further determine the program preference of the user.

8. The program information prompting apparatus according to claim 6, wherein the storage unit further stores an EPG with a television program information, and- the control unit determines the program preference of the user by comparing the preferred channels and the time periods set by the user himself or herself with the television program information in the EPG to further determine the program preference of the user.

9. The program information prompting apparatus according to claim 5, wherein the user identifying unit is a fingerprint identifier, a biological identifier, a pupil identifier or a three-dimensional environment automatic configuration system.

10. The program information prompting apparatus according to claim 5, wherein the user identifying unit comprises:
a photographing unit for obtaining an image of a user; and
an image identifying unit for identifying the identity of the user according to the image.

11. The program information prompting apparatus according to claim 10, wherein when multiple persons are in the image, the image identifying unit chooses one of the persons as an identifying object.
